(19) United States
(12) Patent Application Publication
(10) Pub. No.: US 2010/0232268 A1
(43) Pub. Date: Sep. 16, 2010

(54) METHOD AND APPARATUS FOR RECORDING AND REPRODUCING OPTICAL INFORMATION, AND RECORDING MEDIUM

(75) Inventors: Toshimichi SHINTANI, Kodaira (JP); Hiroyuki Minemura, Kokubunji (JP); Soichiro Eto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Consumer Electronics Co., Ltd.

(21) Appl. No.: 12/709,337

(22) Filed: Feb. 19, 2010

(30) Foreign Application Priority Data
Mar. 16, 2009 (JP) 2009-062237

(51) Int. Cl. G11B 7/00

(52) U.S. Cl. 369/47.5; G9B/7

(57) ABSTRACT

Ordinary optical disks need the resetting of recording conditions in the course of recording to cope with changes in ambient temperature, laser temperature, and medium's recording sensitivity. Optical disks for super-resolution reproduction which are intended to reproduce record marks smaller than the optical resolution, thereby increasing the recording density, need the resetting of recording conditions as well as the condition of super-resolution reproduction because the quality of reproduced signals depends largely on the power for super-resolution reproduction. The power for recording as well as the power for super-resolution reproduction is therefore changed in the course of test recording to detect the deviation from the optimum value of the recording condition to obtain the optimum recording power. In this case, it is also desirable to change the power for super-resolution reproduction in proportion to the power for recording.

### CROSS-REFERENCE TO RELATED APPLICATIONS

This application is related to U.S. application Ser. No. 12/569,059 filed on Sep. 29, 2009, the disclosures of which is hereby incorporated by reference.

### CLAIM OF PRIORITY

The present application claims priority from Japanese patent application JP 2009-062237 filed on Mar. 16, 2009, the content of which is hereby incorporated by reference into this application.

### FIELD OF THE INVENTION

The present invention relates to a technology of large-capacity optical disk and more particularly to a method and apparatus for determining the optimum conditions under which information is recorded in a super-resolution optical disk having a high recording density in excess of the diffraction limit of light.

### BACKGROUND OF THE INVENTION

Among conventional technologies of recording a large amount of information, which are still under research and development, is the high-density optical recording technology capable of storing more information in a unit area. The optical disk technology which has been commercialized so far records and reproduces data on and from a disk by condensing a laser beam thereon by a lens. One way developed heretofore to increase the data density was to reduce the spot size of the condensed laser beam. It is known that the spot size is proportional to λ/NA, where λ denotes the wavelength of the light source and NA denotes the numerical aperture. In other words, it has been common practice to increase the amount of information to be stored in a single disk by reducing the wavelength of the light source and enlarging the NA of the lens. The performance of the currently available CD and DVD may be expressed by a set of three parameters such as (780 nm, 0.5, 650 MB) and (650 nm, 0.6, and 4.7 GB), respectively, where the first to third parameters denote, respectively the wavelength of the light source, the NA of the objective lens, and the capacity of data to be stored in a disk 12 cm in diameter. In the case of technology based on blue laser beam, the foregoing expression may be changed into (405 nm, 0.85, 25 GB) and (405 nm, 0.65, 20 GB). This recording capacity is large enough to record high-definition TV image data for about 2 hours.

However, the recording density mentioned above is not enough for a professional system such as broadcasting and security system. The professional system needs a capacity larger than 100 GB per disk, for instance. Moreover, it is desirable that one disk can store as much data as possible so as to save the space for storage of recording media containing a large amount of data in the case where such recording media have to be stored for a long period of time, say tens to hundred of years. The capacity to meet this requirement is 100 GB to 1 TB or more per disk.

One way proposed heretofore to realize such a large recording capacity was to effectively improve the optical resolution by providing the disk with some sort of mechanism. This will be referred to as super-resolution technique hereinafter.

The super-resolution technique that relies on the phase-change recording film is disclosed in Japanese Journal of Applied Physics, vol. 32, pp. 5210-5213 and JP-A-2006-107588. The phase-change recording film is usually used for the recording film of the rewritable disk such as CD-RW, DVD-RAM, DVD±RW, and Blu-ray Disc. Here, this recording material is not used as the recording film but is used as the layer to effectively improve the optical resolution in the same way as in the reproducing layer of the conventional magneto-optical disk. The layer (film) such as this will be referred to as the super-resolution layer (film) hereinafter. In this case, the data stored on the disk is not recorded in the super-resolution layer mentioned herein but in the other place. For example, in the case of a read-only-memory (ROM) disk, it is recorded as pit on the substrate, and in the case of recordable disk, there is a recording film other than the super-resolution layer mentioned herein and data is stored in that recording film. As a typical example, the layer in which data is recorded and the super-resolution layer are formed in the same way within the focal depth of the beam but the layer spacing distance is tens to hundreds of nanometer. According to this technology, the phase-change recording film is deposited by sputtering on the read only memory (ROM) disk and then it is partly melted at the time of reproduction. If the reflectivity of the disk is sufficiently higher in the molten part, the signals obtained from the molten part become predominant among reproduced signals. That is, the molten part of the phase change film becomes the effective reproducing optical spots. Since the area of the molten part is smaller than the optical spot, the reproducing optical spot reduces and the optical resolution improves.

In JP-A-2006-107588, the concept disclosed in Japanese Journal of Applied Physics, vol. 32, pp. 5210-5213 is advanced further and the method of obtaining the super-resolution effect by forming pits of phase-change material and melting a single pit at the time of reproduction is proposed. According to this proposal, pits of phase-change material are formed by using the phase-change etching method. The phase-change etching method is a technology to perform fabrication by changing the pattern of phase-change marks into projections and recessions, using the fact that the crystalline part and the amorphous part of the phase-change film differ in solubility in an alkaline solution. According to this method, because there exists only in the mark part a substance that exhibits the super-resolution effect and the space part does not need to absorb light, it is possible to increase the optical transmittance of one layer and the combination of the multi-layer technology and the super-resolution technique becomes possible. An example of having realized the dual-layer super-resolution disk by this method is disclosed in Japanese Journal of Applied Physics, vol. 46, pp. 3919-3921. This method will be called the pit-type super-resolution method and the case in which the super-resolution film is formed two-dimensionally and continuously as mentioned above will be called the thin-film-type super-resolution method.

Also, as the other method of improving the recording density in the optical disk, Solid Immersion Lens (SIL hereinafter) has been proposed. According to this method, the size of the record mark is reduced and the recording density is improved by making the NA of the lens larger than 1 and making λ/NA smaller. For example, in Japanese Journal of Applied Physics, vol. 45, pp. 1321-1324, the technology of SIL with NA increased to 1.8 is reported. In ordinary lenses, it is impossible to make NA larger than 1 because refraction takes place at the interface between the lens and air having a refractive index smaller than the lens when light emerges from the lens. According to the system of Japanese Journal of Applied Physics, vol. 45, pp. 1321-1324, NA>1 is realized by bringing the lens and the medium close to each other, with this reason noticed. When the lens and the medium are brought close to each other, the component of NA>1, which does not usually propagate to the lens, combines with the medium surface and is converted into the propagating light, and hence the system of NA>1 is substantially realized. In this case, high-density recording becomes possible by scanning the lens while keeping the distance between the lens and the medium at typically about 20 nm or less.

Moreover, in Japanese Journal of Applied Physics, vol. 44, pp. 3554-3558, the possibility of multilayer recording using the above-mentioned SIL is reported, and in Proceedings of International Symposium on Optical Memory 2007, Tu-G-05 (2007), the configuration of the combination of super-resolution recording and SIL is reported. In the technology of Proceedings of International Symposium on Optical Memory 2007, Tu-G-05 (2007), a further increase in high-density is realized by forming further minute super-resolution spots by using thermal profile within the minute spot formed by SIL.

### SUMMARY OF THE INVENTION

As mentioned above, super-resolution improves the recording density by realizing the effective resolution that exceeds the diffraction limit of light. In this case, the control of the recording conditions becomes important because the size of the record mark is smaller than that of the conventional optical disk. That is, in the case of optical disk, marks are recorded usually by chemical or physical changes which are induced in the recording film by heat generated in the medium by irradiation with light; however, in the case of recording an array of minute marks, it becomes difficult to record high-quality marks due to influence such as thermal interference between marks, for instance. In order to solve this problem, fine adjustment of recording conditions becomes necessary.

Recording conditions depend largely on the thermal properties of the disk, the recording environmental temperature, the fluctuation of characteristic properties of the laser beams as the light source, and the light emitting state. Those disks in actual production have the fluctuation of film thickness and in-plane film state. Therefore, the optimum recording conditions vary along the radius of the disk or even while the disk makes one turn. Moreover, there is an instance in which, when a series of data is recorded, the laser beam begins to emit recording power from the starting point of recording, but the temperature of the laser increases due to emission and the laser emission power and emission waveform change during recording. Thus the optimum conditions change during recording.

In order to solve this problem, it becomes necessary, when a series of data is recorded, to adjust the recording conditions while confirming the quality of previously recorded marks in the course of recording. Here, this will is referred to as OWC (Optimum Write Control; recording condition optimum control). In the case of OWC in the conventional disk that performs normal-resolution readout, the quality of recorded marks is checked by suspending recording once in the course of recording a series of data, for instance, and switching the laser emission power to the reproducing light power and reproducing the previously recorded marks. If this checking reveals a deterioration in the quality of recorded marks, the system finds the optimum recording conditions by, for example, moving the light spot to the recording test area of the disk.

In super-resolution reproduction, it is a characteristic feature to generate a reflection spot effectively smaller than the irradiation diameter of the light spot by using the thermal profile of the light spot impinging on the recording medium. This is synonymous with using heat at the time of recording, and it unit that when the recording conditions depart from the optimum conditions, the super-resolution reproducing conditions also depart from the optimum conditions. Therefore, it follows that if the reproduction conditions are fixed constant at all times, it becomes impossible to verify whether the optimum recording conditions obtained by using OWC are truly optimum. In other words, there is an instance in which even though the drive recognizes that the current recording conditions after execution of OWC is optimum, they are merely optimum conditions verified under reproduction conditions which are in fact not optimum and high-quality marks are not recorded in fact. For example, it is the case in which the mark size is larger than the intended size. In this case, it becomes impossible to obtain sufficient resolution even by super-resolution reproduction, and the bit error rate deteriorates.

FIGS. 2A to 2C show the schematic diagrams of the recording mark size and the super-resolution spot size in the case where departure of the recording and super-resolution reproduction conditions has occurred. Here, for simplicity, it is assumed that the medium is a write-once optical disk in which the record mark size is approximately proportional to the energy of laser irradiation. It is also assumed that the super-resolution reading power (Psr) is effectively DC power. FIG. 2A shows the relationship between the optimum recording power to record the mark 203 of the size necessary to realize the target recording density in the case where the writing power (Pw) and reading power (Psr) are optimum and the size of the light spot 201 in the case where reproducing power necessary to obtain the super-resolution spot from which high-quality reproduction signals are obtained, the mark 202, and the super-resolution spot 203. FIG. 2B is, the case in which Pw and Psr are smaller than the optimum values, and FIG. 2C is the case in which Pw and Psr are larger than the optimum values. In FIG. 2B, both the record mark 203 and the super-resolution spot 202 are small, and in FIG. 2C, both are large.

For example, in FIG. 2B, the size ratio of super-resolution spot and record mark is approximately equal to the case of FIG. 2A and hence reproduction of the shortest marks is possible. However, because the super-resolution spot size has been reduced, the super-resolution signal amplitude becomes small and the S/N ratio of the reproduction signals decreases. The case under this condition is considered in which Psr is kept constant at all times and only Pw is adjusted. Now, it is assumed that the drive has detected by some unit whatsoever that Pw is insufficient and Pw is increased accordingly; then the record mark becomes larger as compared with the super-resolution spot size and the shape of the reproduction signals departs from the desired shape. In the case where the Viterbi decoding is employed as the decoding method of reproduction signals, shape departure of the reproduction signals particularly becomes a problem. As the result, there arises an instance in which the Euclidean distance does not become minimum between the binary code array obtained from the actual reproduction signals and the binary code array which is the correct decoding target (or the binary code array recorded in the recording medium) in the maximum-likelihood calculation at the time of Viterbi decoding, depending on the shape of the reproduction signals, and this becomes the cause of decoding errors. Moreover, since Psr is constant, the super-resolution spot that is formed at the time of reproduction remains smaller than the super-resolution spot in the optimum reproducing state and the S/N of the reproduction signals still remains low. Since the physical index used to optimize Pw at the time of OWC execution acquires based on the reproduction signals, the accuracy itself of OWC may also decrease if the S/N of the reproduction signal is low.

Next, the case of FIG. 2C is considered. In this case, the S/N of the reproduction signal is large because the super-resolution spot is large, but edge shift occurs in the reproduction signal because the record mark size is large. If, assuming that the drive has detected by some unit whatsoever that Pw is larger than the desired value, Pw is reduced and OWC is executed while Psr remains constant, the record mark size becomes smaller as compared with the super-resolution spot size and hence the resolution of particularly the shortest mark becomes insufficient. As the result, it becomes impossible to obtain high-quality reproduced signals and hence it becomes impossible to determine the optimum value of Pw.

As mentioned above, in the super-resolution optical disk, if the super-resolution reading power Psr is kept constant at the time of OWC, it becomes impossible to optimize the recording conditions.

The above-mentioned problem is solved by adjusting the super-resolution reproducing conditions together when the recording conditions are optimized. To be more specific, the above-mentioned problem is solved by changing the reproducing conditions in conformity with the optimized recording conditions when the verification is executed to see whether the determined recording conditions are optimum in a series of OWC process. This is because recording as well as super-resolution reproduction are carried out by creating a desirable temperature distribution in the medium, and if the profile of temperature distribution used to perform recording changes, the temperature distribution profile to be created in the medium to perform super-resolution reproduction should also change as a matter of course. Incidentally, the adjustment of the recording conditions and reproducing conditions may be accomplished not only by adjusting together the reproducing conditions in conformity with the recording conditions but also by adjusting the recording conditions in conformity with the reproducing conditions. That is, it is necessary to execute the adjustment of the recording conditions and the adjustment of the reproducing conditions in pairs. The details of the above-mentioned OWC process will be described in embodiments.

It becomes possible to correct without errors the departure from the optimum values of recording power and reproducing power that results from the drive ambient temperature and the fluctuation of in-disk thermal sensitivity, for the super-resolution reproducing technology that realizes the higher density and capacity of recording data by making it possible to reproduce minute marks in excess of optical resolution limit.

### BRIEF DESCRIPTION OF THE DRAWINGS

FIG. 1 is a flowchart of the entire action of the drive according to the present invention;

FIGS. 2A to 2C are schematic diagrams of recording mark size and super-resolution spot size in the case where the recording power and super-resolution reproducing power depart from the optimum values: FIG. 2A shows the case where the recording and reproducing powers are the optimum values, FIG. 2B shows the case where the recording and reproducing powers are smaller than the optimum values, and FIG. 2C shows the case where the recording and reproducing powers are larger than the optimum values;

FIG. 3A is a diagram illustrating the structure of the optical disk drive used to verify the effect of the present invention;

FIG. 3B is a diagram illustrating the flow of determining the recording power and reproducing power in the first embodiment;

FIG. 3C is a diagram illustrating the detailed steps of test write;

FIG. 3D is a diagram illustrating the detailed steps of test readout;

FIG. 4 is a diagram illustrating the structure of the optical disk tester used to verify the effect of the present invention;

FIG. 5 is a diagram illustrating the recorded waveforms used in the third embodiment of the present invention;

FIG. 6 is a graph showing the distribution of jitter values which was obtained in the case where the super-resolution reproducing power was not controlled within one turn of the disk in the case where the super-resolution technique was combined with the multi-layer SIL recording; and

FIG. 7 is a graph showing the optimum super-resolution reproducing power within one turn of the disk in the case where the present invention was applied to SIL recording.

### DETAILED DESCRIPTION OF THE PREFERRED EMBODIMENTS

In what follows, a description is given of the embodiments of the present invention. First of all, a description is given of the problems for solution which are common in all the embodiments and the principle and structure of the unit for solution of the problems.

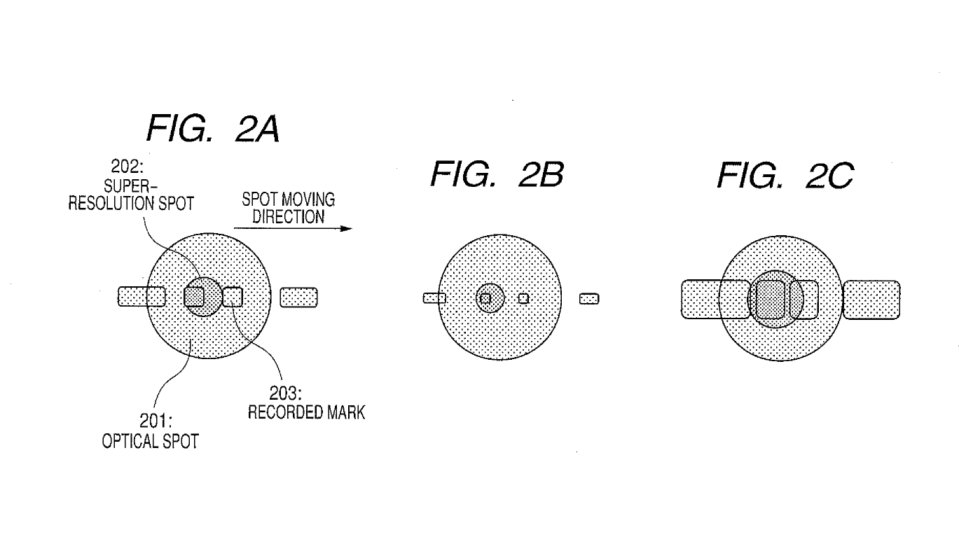

The first case to consider arises when the temperature that occurs in the medium due to laser irradiation decreases for some reason or other as shown in FIG. 2B. In this case, the mark width decreases in both long marks and short marks; however, since the super-resolution spot size also decreases in the same way, asymmetry in the reproduced signals is approximately identical with asymmetry of the reproduced signals which are obtained in the case of optimum conditions.

However, the reproduced signal amplitude decreases because the super-resolution spot size decreases. Also, since the mark length becomes shorter than the intended length, edge shift occurs in the reproduced signals. Since the contraction of the mark length occurs at both ends of the mark, the edge shift occurs in the direction in which the leading edge falls behind and the trailing edge advances. Also, in the case of FIG. 2C, which is in reverse of the case of FIG. 2B, the reproduced signal amplitude increases and the edge shift occurs in such a direction that the leading edge advances and the trailing edge falls behind. Therefore, for example, by detecting the reproduced signal amplitude I_{L} of the long mark and the edge shift of the signal, it is possible to know whether the recording power and the super-resolution power are insufficient or excessive.

In the above-mentioned case, it is necessary to previously know the optimum value of the indicator function such as the I_{L} and the edge position. For this purpose, one performs the test of recording and reproduction prior to the start of recording and reproduction, thereby detecting the optimum value of the indicator function in the combination of the disk and the drive. In this test, the adjustment of the recording power Pw and the recording waveform as well as the adjustment of the super-resolution reproducing power Psr are necessary.

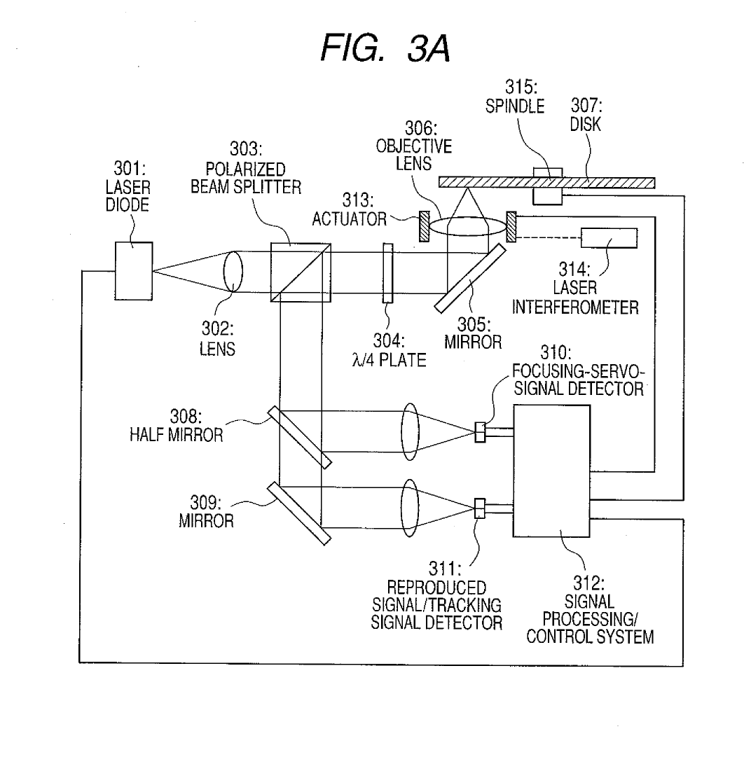

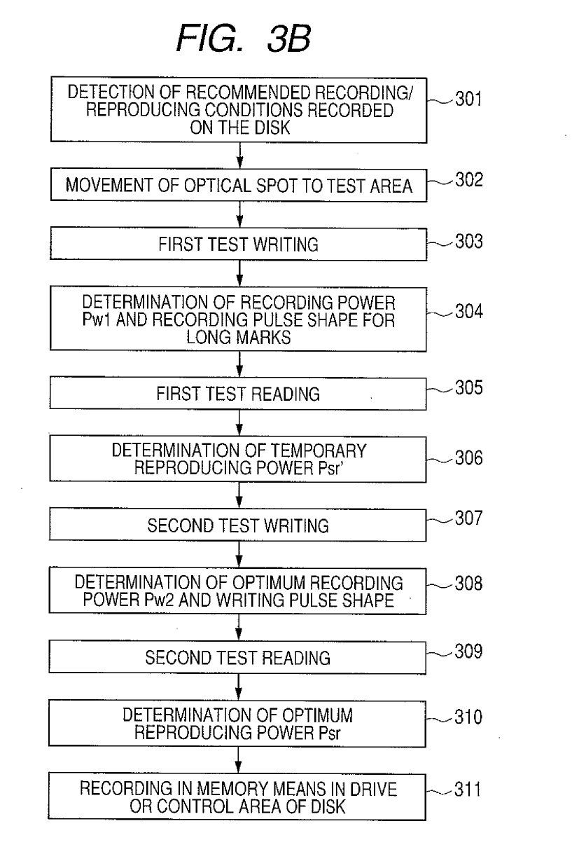

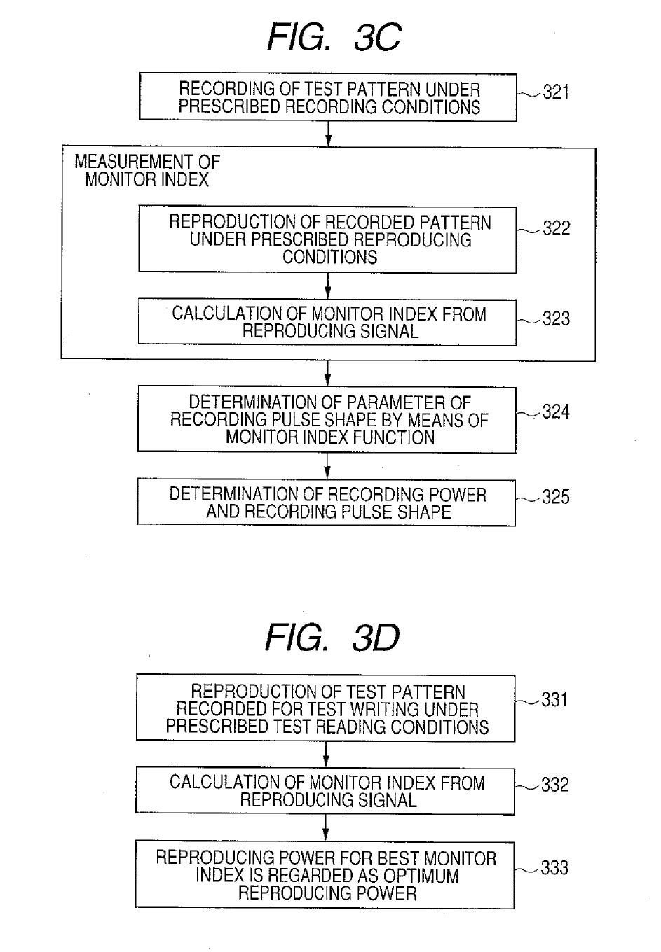

The adjustment method is described below. In the OWC process according to the embodiment of the present invention, basically, Psr is changed in proportion to Pw. For example, it is assumed that the state in which power is insufficient as shown in FIG. 2B has been detected. In this case, if Psr is increased in proportion to Pw, it is possible to bring close to the state of FIG. 3A. Conversely, in the case of FIG. 2C, Psr is reduced in proportion to Pw. This is because the laser beam directed to the recorded mark at the time of reproduction is usually DC (the irradiation intensity is approximately constant with respect to time) and in the case where the dc-power laser is irradiated, the temperature that occurs in the medium is proportional to the energy per unit area of the light spot directed to the medium. Consequently, by changing Pw and Psr proportionally and detecting I_{L} or edge shift, it is possible to search simply the optimum value of both Pw and Psr.

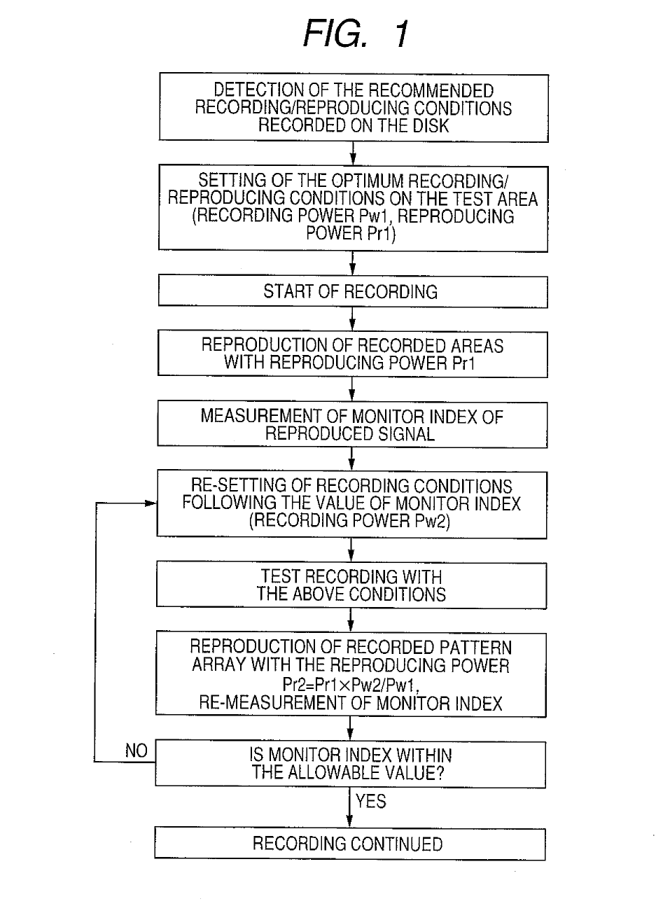

The flowchart that summarizes the foregoing flow is FIG. 1. Basically, it is a repetition of flow of performing test recording under prescribed conditions and resetting the recording power, resetting the reproducing power Pr2 corresponding to the reset recording power Pw2 by using the ratio of the reset recording power Pw2 and the recording power before resetting, and verifying the competence of the recording power by using the monitor index that is obtained by reproducing the test pattern with the reset reproducing power Pr2.

Now, in the OWC process according to this embodiment, there is a problem that what should be used as an evaluation index of power of Pw at the time of optimizing Pw by using the indicator function that is obtained from reproduced signals. In general, the recorded waveform of laser beam directed to the recording medium at the time of recording action, as the evaluation index of power of Pw, is composed of a plurality of laser pulses (called write strategy), and it follows therefore that an average power of waveform containing a plurality of pulses is used. This is because the thermal profile which is formed in the medium at the time of recording to super-resolution reproduction is proportional to the average power. However, this recorded waveform or the parameter that determines the pulse waveform roughly contains as many as five parameters such as upper and lower two power values, the duty of pulse, and the lengths of the first pulse and last pulse. Therefore, how to determine the evaluation index of Pw from the recording pulse shape containing such a large number of parameters is a problem. The most effective method is to make the average power Pw of that part (called successive pulse part), which remains after the first pulse and last pulse are eliminated from the pulse waveform, the power index of Pw. This is because the main role of the first pulse and last pulse is the adjustment of the mark length and what mainly determines the mark width is the successive pulse part. The power of the successive pulse part is expressed as αPᵤ+(1−α)P_{b}, where Pᵤ and P_{b} denotes respectively the high power and the lower power of the pulse train containing the successive pulse part, and α denotes the ratio of the pulse irradiation time (total sum of continuous time of individual pulses) to the total pulse irradiation time contained in the successive pulse part. Therefor, the proportional relationship between Psr and Pw is expressed as Formula I below.

Pₛᵣ∝αPᵤ+(1−α)P_{b} (1)

Here, changing Pw and Psr proportionally requires that the proportionality constant of Pw and Psr should be previously established. To this end, a step of determining the optimum values of Pw and Psr is necessary. There are several conceivable processes to achieve this. One of them is to set up a test recording area on the disk and perform reproduction by normal-resolution readout to reproduce with a lower power instead of super-resolution reproduction and determine the Pu, Pb, α, and the lengths of the first pulse and last pulse only with the mark length larger than the diffraction limit of light. After that, it performs super-resolution reproduction and searches for the reproduction power with which the resolution of the reproduced signal becomes maximum. It makes this the optimum Psr and then records the mark train containing the mark length smaller than the diffraction limit of light, reproduces it with Psr, and finds the recording conditions under which any one of the asymmetry of reproduced signal, resolution, jitter, and bit error rate becomes optimum. Alternatively, it is possible to prepare an embossed data array having the desired mark length at a prescribed place on the disk, perform super-resolution reproduction on the mark train, and determine the super-resolution reproducing power Psr so that the reproduced signals have the desired properties.

### First Embodiment

The first embodiment is concerned with an optical disk drive which has the function of performing the adjustment of recording power and super-resolution reproducing power by detecting such events as change in ambient temperature and change in laser temperature.

FIG. 3A is a diagram showing the structure of the drive. The laser diode 301 emits a laser beam, which is collimated by the lens 302. The collimated beam passes through the polarized beam splitter 303. At this time, the laser beam emerging from the laser diode 301 is linearly polarized, and the direction of the polarized beam splitter 303 is previously adjusted so that the direction of polarization coincides with the polarized beam splitter 303 for complete light passage. The laser beam is converted into circularly polarized light by the λ/4 plate 304. The circularly polarized light passes through the mirror 305 and the objective lens 306 and focuses on the disk 307. The reflected light from the disk passes through the objective lens 306 and the mirror 305, and is converted into linearly polarized light by the λ/4 plate 304. The resulting polarized light has the direction of polarization which differs by 90° from that of the laser beam emerging from the laser 301. This light enters the polarized beam splitter 303, which bends its optical path by 90°, and then enters the focusing signal detector 310 and the reproducing/tracking signal detector 311. Signals from both detectors are entered into the signal processing/control system 312. At the same time, the laser interferometer 314 detects the radial position of the head, and its signal is entered into the system 312. This system controls the auto-focusing servo, tracking signal, laser-pulse generating signal, and disk rotation speed. Here, the wavelength of the laser diode 301 is 405 nm and the numerical aperture of the objective lens 306 is 0.85. The control system performs general control over the entire action of the drive and also performs arithmetic controls necessary for the recording and reproducing action. Incidentally, although not shown, the drive according to this embodiment has a resistivity detecting device in the laser diode so that it detects the change in resistance of the resistivity detecting device and senses the change in the laser temperature.

The action of OWC of the optical disk drive shown in FIG. 3A will be described below with reference to FIGS. 3B to 3D. First, the drive as shown in FIG. 3A is fed with a write-once super-resolution disk. This disk for super-resolution reproduction is characterized by the window width Tw of 25 nm, the encoding code of 1-7 encoding, and the track pitch of 320 nm. In other words, the shortest mark length is 50 nm equivalent to 2 T mark and the longest mark length is 200 nm equivalent to 8 T mark. First, the drive moves the head to the control data area of the disk which is formed near the disk radius of 25 mm and detects the disk type described in terms of wobbled data of groove. So, the drive recognizes that the disk is a once write super-resolution disk. Then, the drive detects the recommended recording power Pw1, super-resolution reproducing power Pr1, and information about write strategy (the recommended values of parameters to determine the recording pulse shape), which are recorded in the above-mentioned region of the disk (Step 301), and sets the driving conditions of the laser diode driver to the above-mentioned value. In this embodiment, it is assumed that the Pw1=6.0 mV and Pr1=0.3 mW.

Then, the drive moves the head to the recording/reproducing test area which is provided near the radius of 25.3-25.5 mm and executes the first test write (Step 302). In this embodiment, “test write” unit the process of recording a prescribed test pattern by a laser beam with a varied recording power on the recording medium, calculating an adequate evaluation index value from the reproduced signals obtained by reproducing the test pattern, and selecting the recording power for best reproducing characteristics. The details of the steps to be executed in test write are shown in FIG. 3C. Incidentally, FIG. 3C also explains the steps to be executed in the second test write step 307, therefore, the details of the steps to be executed in the first test write and the second test write is slightly different from FIG. 3C. The different part will be explained by sentences.

First, the drive records a mark string composed of marks whose length is larger than 4 T under the recommended recording conditions recognized above in the above-mentioned recording/reproducing test area (Step 321). In the case of this embodiment, any mark above 4 T longer than the limit of the optical resolution is regarded as a long mark. After that, the drive executes the step of measuring the monitor index. This step is composed of the sub-step of reproducing the recorded mark string with 0.3 mW which is the recommended reproducing power Psr1 (Step 322) and the sub-step of calculating the monitor index from the reproduced signals (Step 323). In this embodiment, asymmetry was measured as the monitor index. Here, if the upper level and lower level of the reproduced signals of the longest mark are written as I_{LH} and I_{LL} and the upper level and lower level of the reproduced signal of the part of the repeated pattern of the shortest mark are written as I_{SH} and I_{SL},

$$Asym = \frac{( {I}_{LH} + {I}_{LL} ) - ( {I}_{SH} + {I}_{SL} )}{2 ( {I}_{LH} - {I}_{LL} )}$$

Then the asymmetry is represented as above.

The arithmetic processing of the monitor index is executed by the control system 312. Next, the drive determines the recording power and the recording pulse shape according to the monitor index (Step 324). In this embodiment, the asymmetry which is the monitor index is described in terms of the function (called monitor indicator function hereinafter) whose variable is the parameters (recording power Pu, Pb, and pulse duty α) contained in the recording pulse shape. In this embodiment, the drive adjusts the parameter of the monitor evaluation function so that the asymmetry is nearly zero and determines the recording power Pu, Pb, and pulse duty α.

After the drive has determined the recording power Pu, Pb, and pulse duty α, it determines the length of the first pulse and the last pulse so that the length of each mark becomes the desired length (Step 325). The arithmetic processing of the above-mentioned parameters is executed by the control system 312. Thus the recording condition for marks above 4 T is determined (Step 304).

Subsequently, the drive executes the first test readout step (Step 305). The details of the step to be executed by test readout are shown in FIG. 3D. In this embodiment, “test readout” unit the process of irradiating the recording medium several times with reproducing light varying in power and calculating an adequate evaluation index value from the thus obtained reproduced signals, thereby selecting the reproducing power which has the best reproducing characteristics. Like FIG. 3C, FIG. 3D also illustrates the step to be executed in the second test readout step 309; therefore, that part different from FIG. 3C in the steps executed by the first test readout and the second test readout will be explained by sentences.

In test readout in Step 305, the drive reproduces the mark string recorded by the first test write at intervals of 0.1 mW within ±20% of the recommended reproducing power Psr1 recognized above (Step 331). Then the drive calculates the monitor index from the thus obtained reproduced signals (Step 332), and it assigned the reproducing power for which the monitor index indicates the best value to the temporary super-resolution reproducing power Psr′ (Step 333). The arithmetic processing to calculate Psr′ is executed by the control system 312. In this embodiment, the monitor index to be used to adjust the super-resolution reproducing power by performing test readout uses the resolution which is an index differing from the monitor index to be used in test write. This is because if the same monitor index is used, it is difficult to adjust two parameters by one monitor index.

Subsequently, the drive executes the second test write to determine the recording pulse shape for short marks below 3 T (Step 307). This will be described below with reference to FIG. 3C. First, the drive records marks (test pattern) of 2 T to 8 T including short marks (Step 321). The recording conditions for recording the test pattern is the recording condition obtained from the first test write for the marks above 4 T and the recommended recording conditions for marks of 2 T and 3 T which are short marks.

Then, the drive reproduces the recorded mark string with Psr′ (Step 322) and calculates the monitor index (Step 323). In this embodiment, the monitor index that is used at the time of test write is asymmetry, and in Step 324 it uses the same monitor indicator function as used at the time of the first test write, and it obtains the recording power Pu, Pb, and pulse duty α so that the asymmetry becomes nearly zero (Step 324). After that, the drive determines the lengths of the first pulse and the last pulse in the same way as in the first test write (Step 325). The foregoing step determines the final recording conditions (the optimum recording power Pw2 and the recording pulse shape) for 2 T-8 T marks (Step 308). The arithmetic processing to determine the parameters of the recording waveform is executed by the control system 312.

Subsequently, the second test readout to determine the final super-resolution reproducing power is executed (Step 309). In the following, a description is given with reference to FIG. 3D. In the second test readout, the drive reproduces the mark string of 2 T to 8 T recorded in Step 307 at intervals of 0.1 mW within the range of ±20% of Psr′ (Step 331), calculates the resolution from the reproduced signals (Step 332), obtains the power with which the maximum resolution is obtained, and assigned it to the optimum super-resolution reproducing power Psr (Steps 333 and 310). The arithmetic processing to calculate Psr is executed by the control system 312. The drive records and holds these optimum recording conditions and super-resolution power Psr and the reproduced signals in the control area within the disk or in the flash memory provided in the control system 312 (Step 311)

After the drive has completed the setting of the recording and reproducing conditions under the foregoing condition, it starts recording and reproduction. At the time of performing a series of recording, it detects the temperature in the drive and the laser temperature. When either the drive temperature or the laser temperature fluctuates more than 10° C. from the temperature at the time when the optimum recording and reproducing conditions have been determined, the drive suspends the recording there and reproduces, with the power of Psr, the data recorded up to that time. Here, if the reproduced signal amplitude differs more than 5% from the amplitude of the signals recorded and reproduced under the above-mentioned optimum conditions, the drive resets the recording and reproducing conditions. The drive performs this resetting by moving the head to the recording/reproducing test area.

First, the drive records and reproduces the mark string under the currently set conditions and measures the signal amplitude. If the thus measured signal amplitude is smaller than that obtained when the optimum condition has been set up, the drive increases Psr by units of 0.05 mW; otherwise, the drive decreases Psr by units of 0.05 mW. In this case, the drive sets up the recording power such that Pb and α are constant and Pu is the value determined by the formula (1). After the drive has adjusted the signal amplitude, it determines the lengths of the first pulse and last pulse so that jitter becomes minimal. After that, the drive returns the head to the track for previous recording and starts the recording of continued data. As the result, the drive is capable of continuous recording for one hour with a bit error rate lower than 10⁻⁶. This result is favorably compared with that in the case where the bit error rate deteriorates to 10⁻⁴ after continuous recording for 20 minutes or longer if the resetting of conditions is not performed.

In the foregoing steps, the drive uses the signal amplitude, resolution, and jitter as the monitor index to determine the power, but it may also use other parameters as the monitor index. Here, the same effect as above can be obtained even though asymmetry, jitter, and bit error rate are used to judge as to whether or not the recording and reproducing conditions are off the optimum condition.

This embodiment has been described above on the assumption that the event for reexecution of OWC is change in drive temperature or laser temperature; however, the drive may also adjust the optimum power by detecting other events, such as change in the disk position. This is because there is an instance in which the thin film on the disk slightly fluctuates in thickness and composition depending on the disk position. In this case, it is desirable for the drive to establish the region for OWC at a prescribed position on the disk, such as the inner-radial area, middle-radial area, and outer-radial area, and perform OWC at individual positions.

As mentioned above, the optical disk drive according to this embodiment executes the OWC flow by performing adjustment of the recorded pulse waveform and adjustment of the super-resolution reproducing power as one set. Therefore, it is able to correctly adjust the recorded pulse waveform. Moreover, the drive adjusts the recording and reproducing conditions for long marks and adjusts the recording and reproducing conditions for short marks in separate steps; therefore, it is able to adjust the recording conditions for marks longer than optical resolution and adjust the condition for super-resolution reproduction of marks shorter than optical resolution. Incidentally, the foregoing description is based on the flow in which the conditions for reproduction is adjusted in response to change in the condition for recording (that is, test write is performed first ant then test readout is performed). Needless to say, the flow in which the order of adjustments is reversed is covered by the present invention.

### Second Embodiment

In this embodiment, the drive has almost the same structure as that in the first embodiment except that it employs a disk having emboss data.

The drive is fed with a once write super-resolution disk. It operates in the same way as in the first embodiment up to the step of detecting the recommended recording and reproducing condition.

Next, the drive moves the head to the area of radius 25.1 to 25.2 mm of the disk in which a data string composed of embosses of length 2 T to 8 T is formed. The drive performs reproduction while varying the reproducing power by units of 0.1 mW within ±20% of the recommended reproducing power. The reproducing power that minimizes the jitter of the emboss data is assigned to the temporary super-resolution reproducing power Psr′. The thus obtained value of Psr′ and its reproduced signals are recorded in the flash memory provided in the control system 312.

Then, the drive moves the optical spot to the recording/reproducing test area. The control system 3212 is able to judge, from the address to which the optical spot has been moved, that the destination of movement is the region available for recording. The drive records the test pattern with the recommended recording power and reproduces it with the power of Psr′. Then the drive records the test pattern, with Pu varied, and reproduces the recorded test pattern with Psr′ without varying the reproducing power. The drive calculated Pu at which the minimum jitter is obtained from the reproduced signals thus obtained and the drive assigns this to the optimum recording condition.

Next, the drive reproduces the data string recorded under the optimum recording condition within ±20% of Psr′ and assigns the reproducing power with which the minimum jitter is obtained to the optimum super-resolution reproducing power Psr. The reason why the process to readjust this last reproducing power is necessary is that the optimum reproducing power for the emboss data part is not necessarily identical with that for the recorded mark part. This is because the emboss data, which is composed of spaces and pits so that the heat diffusivity differs between them, is usually different from the part available for recording in which the super-resolution spot size is a continuous groove.

The optimum recording and reproducing conditions and the reproduced signals thus obtained are recorded in a flash memory provided in the control system 312.

The drive starts the recording and reproduction for this disk. When the drive temperature or the laser temperature fluctuates more than 10° C., the drive moves the head to the embossed area and readjusts the super-resolution reproducing power. The drive varies the current reproducing power within ±20% to obtain the power that gives the minimum jitter. The temporary super-resolution reproducing power thus obtained is written as Psr′. The optimum super-resolution reproducing power to be newly set up is written as P_{sr, new} which is represented by the formula below.

$${P}_{sr , new} = \frac{{P}_{sr}^{″}}{{P}_{sr}^{′}} {P}_{sr} \qquad ( 2 )$$

Pu is established so as to satisfy the formula (1). Here, Pb and α are kept constant at all times. Then, the drive moves the head to the recording/reproducing test area and determines the lengths of the first pulse and last pulse so that the jitter becomes minimal.

In this embodiment, the drive executes the first test write by using the emboss-formed pre-pit and readjusts the waveform of recorded pulse after the occurrence of events; therefore, the drive skips the step of recording the test pattern. This reduces works to determine Psr,new and Pu and hence permits the drive to reset up the recording and reproducing condition within a short time. The events to be detected are not limited to temperature changes as a matter of course. Also, it goes without saying that the same flow as in the first embodiment may be used to adjust the recording condition after the reproducing condition has been set up.

### Third Embodiment

The following describes the method for verifying the effect of this embodiment by unit of an optical disk tester.

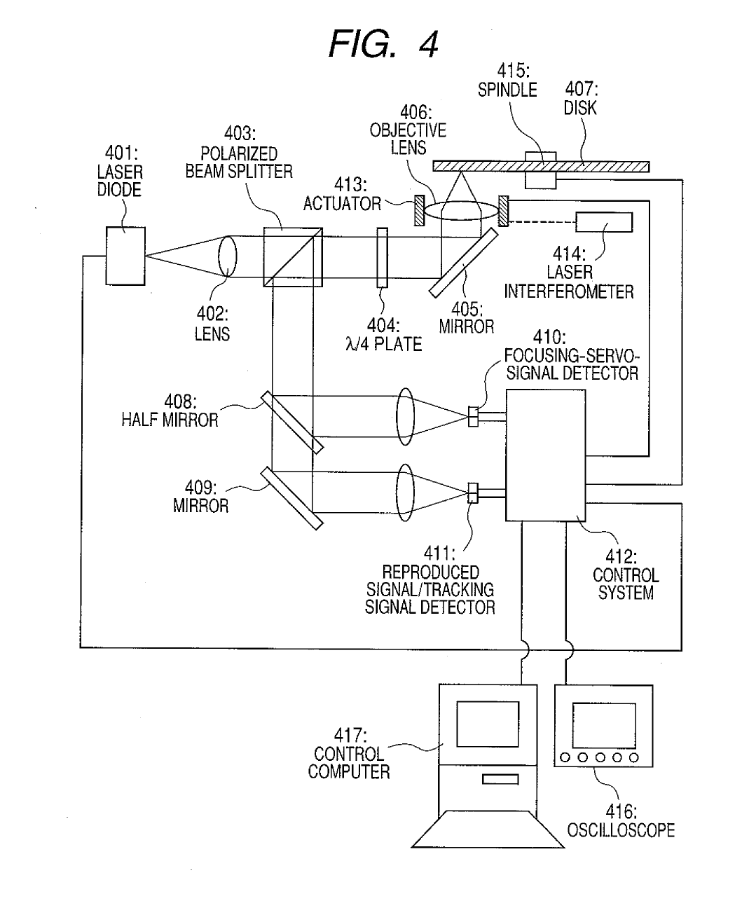

FIG. 4 is a diagram showing the structure of the optical disk tester. The optical disk tester is almost identical in its function and action with the optical disk drive shown in the first embodiment. The difference between them lines in addition of the oscilloscope 416 which permits one to observe reproduced signals and servo signals and addition of the control computer 417 which permits one to control the tester's action and the offset of servo signals and to control the head position, the laser irradiation timing, and the waveform and power of the laser beam.

With the once write super-resolution disk 407 inserted, the tester turns the spindle 415 and fixes the optical spot at a prescribed position on the disk by unit of servo mechanism.

The disk used in this embodiment is a brand-new one (before shipment) which does not bear the recommended recording and reproducing condition recorded thereon unlike the one in the first and second embodiments. Thus, the first operation by the tester was to determine the recording waveform. As in the foregoing embodiments, Tw is 25 nm and the encoding code is 1-7 modulation.

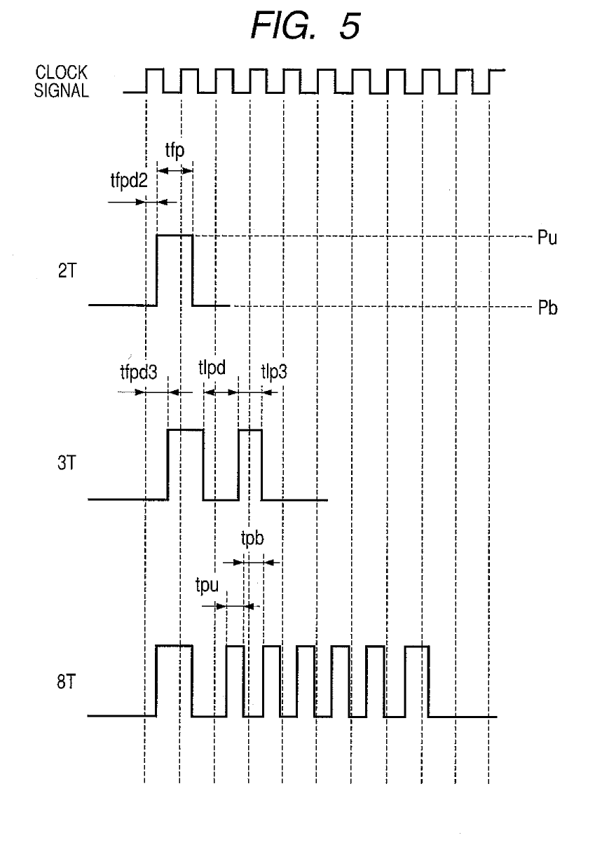

The expected recording waveform is shown in FIG. 5. The value of recording power to be used for recording all marks is the upper level Pu and the lower level Pb. The nT mark was recorded with n−1 pulses. The parameters for recording 2 T mark include tfp (pulse width) and tfpd2 (delay of start timing of pulse relative to the clock signal). The parameters for recording 3 T mark includes tfpd3 (start timing of first pulse), tlpd3 (delay of start timing relative to the second pulse or last pulse), and tlp3 (length of the second pulse or last pulse). Those marks longer than 4 T have tfp (length of first pulse) and tlpd (delay of start timing of last pulse) in common. Their parameters include tfpd (start timing of first pulse) and tpu and tpb (upper level and lower level of successive pulse part). Here, tfpd (start timing of first pulse) and tlp (length of last pulse) are the parameters that depend on the space length before and after that mark. However, in the case where the space length is larger than 5 T, all the parameters are common. Marks of length n larger than 4 T are recorded such that the number of successive pulse parts (excluding the leading and last pulses) is n−3. The tpu and tpb of these n−3 pulses are all identical.

First, the tester moved the head to the disk radius 40 mm, and it recorded a continuous pattern of 24 T mark-24 T space (24 T pure-tone pattern) and reproduced that mark string with a reproducing power 0.3 mW. The reason why the mark length is 24 T here is that 24 T corresponds to 600 nm and sufficiently larger than the light spot size (λ/NA is approximately equal to 480 nm) and hence the tester can detect the position of the front and trailing edges of the mark without inter-symbol interference. By using this, the tester adjusted Pu and Pb and the length and timing of the first pulse and the length and timing of the last pulse such that the reproduced signal has a desirable amplitude and the front and trailing edges are at the desired positions. The temporary recording power obtained here is written as Pu′ and Pb′.

Then, the tester recorded a pure-tone pattern of length 2 T with Pu′ and measured the amplitude of reproduced signals by varying the reproducing power from 1 mW to 4 mW by units of 0.1 mW. Here, the reproducing power that gives the maximum amplitude is referred to as the temporary super-resolution reproducing power Psr′.

Next, the tester recorded random patterns having a mark length and a space length from 2 T to 8 T and reproduced them with a power of Psr′, and it readjusted Pu and Pb and the length and timing of the first pulse and the length and timing of the last pulse so that the asymmetry of the reproduced signals became nearly zero. Then, the tester reproduced, with Psr varied, the mark string which had been recorded under the recording condition which brings the asymmetry to nearly zero, and measured its jitter. Here, the width of variation of Psr is ±40% of Psr′. The Psr that gives the minimum jitter is referred to the optimum super-resolution reproducing power. The results thus obtained were Psr=2.0 mW, Pu=7.0 mW, Pb=0.3 mW, tfpd=6 nm, tfp=15 nm, tpu=tpb=12.5 nm, and tlpd=14 nm, and the jitter obtained here was 7.2%.

Next, the tester recorded random patterns at the disk radius 25 mm under the same recording condition as above, reproduced them with the above-mentioned Psr, and measured jitter. The jitter thus measured was 10.2%. The tester performed recording and reproduction while keeping the recording waveform unchanged and keeping Pb=0.3 mW and (Pu+0.3)/Psr=7.3/2.0 fixed and varying Pu by units of 0.1 mW, and finally observed the signal amplitude of 8 T mark. The result was that the signal amplitude becomes maximum when Pu=7.2 mW and Psr=2.05 mW. So, the tester detected the mark edge position of each mark length while fixing Pu at 7.2 mW and adjusted the length and timing of the first pulse and the last pulse so that the mark edge is nearest the desired position. This resulted in a jitter of 7.5%.

### Fourth Embodiment

This embodiment is concerned with the method of OWC in the case where the multilayer SIL recording and the super-resolution reproduction are combined together. The problem that arises when super-resolution reproduction is applied to the multilayer SIL recording is a focusing error. The optical pick-up system for multilayer SIL recoding has the objective lens (for focusing) arranged on SIL. And the SIL and the objective lens are fixed because the margin for adjustment of their position is narrow. For this system to realize multilayer recording, light should be focused on the deeper layer of the medium. In the system having two lenses fixed, the focusing position of the light spot is determined by the lens surface of the SIL. The lens surface of the SIL levitates about 20 nm above the surface of the medium. Unfortunately, the medium has a cover layer several micrometers thick on its surface and also has a spacer layer several micrometers thick between the recording layers. Consequently, the distance between the lens surface of SIL and the recording layer of the medium fluctuates while the disk makes one turn. However, the system having two lenses fixed as mentioned above cannot follow focusing errors which fluctuate at such a high frequency. As the result, it is necessary to compensate the reproducing power in the defocused state. This leads to deterioration of reproduced signals due to defocusing in the system that applies super-resolution reproduction to the multilayer SIL recording.

This problem can be solved by adjusting the reproducing power in conformity with the size of the super-resolution spot. In the case of super-resolution reproduction, the high-resolution signal component can be obtained by the super-resolution spot. The size of the super-resolution spot depends on the super-resolution reproducing power; therefor, it is possible to keep constant the super-resolution reproduced signals by varying the reproducing power such that the size of the super-resolution spot remains constant at all times within one turn of the disk. This unit for solution is unique to super-resolution reproduction, and in the case of normal-resolution readout, the above-mentioned problem cannot be solved by compensation of the reproducing power. However, in the case of super-resolution reproduction, the effective spot size depends on thermal profile (or reproducing power) and hence it is possible to compensate defocusing to some extent by adjusting the reproducing power. However, if the reproducing power is to be varied, the recording power should also be varied within one turn.

Therefore, the drive of this embodiment has the function of compensating the recording power for the disk in response to the amount of compensation of super-resolution reproducing power for thickness unevenness. A specific structure of the drive will be described below with reference to the drawing.

The structure of the drive is almost the same as that of FIG. 3A. However, the distance between the SIL and the medium was controlled by keeping constant the amount of the near-field light, which after being induced by the lens surface of SIL, combines with the medium surface to become propagating light and impinges upon the light detector 311. In this case, the amount of light fluctuates due to recording marks and disk noise, and hence the signal bandwidth was made below 10 kHz by a high-pass filter. With this signal bandwidth, signals are nearly constant so long as the distance between SIL and medium is constant, and the lens cannot move with the frequency bandwidth above this due to the mass of the lens system and hence the distance between SIL and medium remains nearly constant.

The wavelength of the light source of the drive was 405 nm and the NA of SIL was 1.8. Since λ/NA is 225 nm, the size of diffraction limit (λ/4NA) becomes 56 nm. The Tw of the disk was 12.5 nm, and the encoding code was 1-7 modulation. The track pitch was 150 nm.

As in the second embodiment, the drive read out the recommended recording and reproducing condition which had been recorded as wobbled data in the disk. The result was Pu=5.2 mW, Pb=0.3 mW, Psr=1.4 mW, and the ratio of tpu to tpb in the successive pulse part, tpu/tpb=0.6/0.4. Then, the drive moved the head to the emboss data part formed at the disk radius 25.0-25.3 mm. In this emboss data part is recorded the random data of the above-mentioned mark size. This emboss data was prepared by electron lithography when the master for the patterning of the substrate was produced.

A dual-layer medium was prepared, which has a 2-μm thick cover layer and a 3-μm thick spacer layer between two layers. The recording layer was that of once write type which does not permit data rewriting.

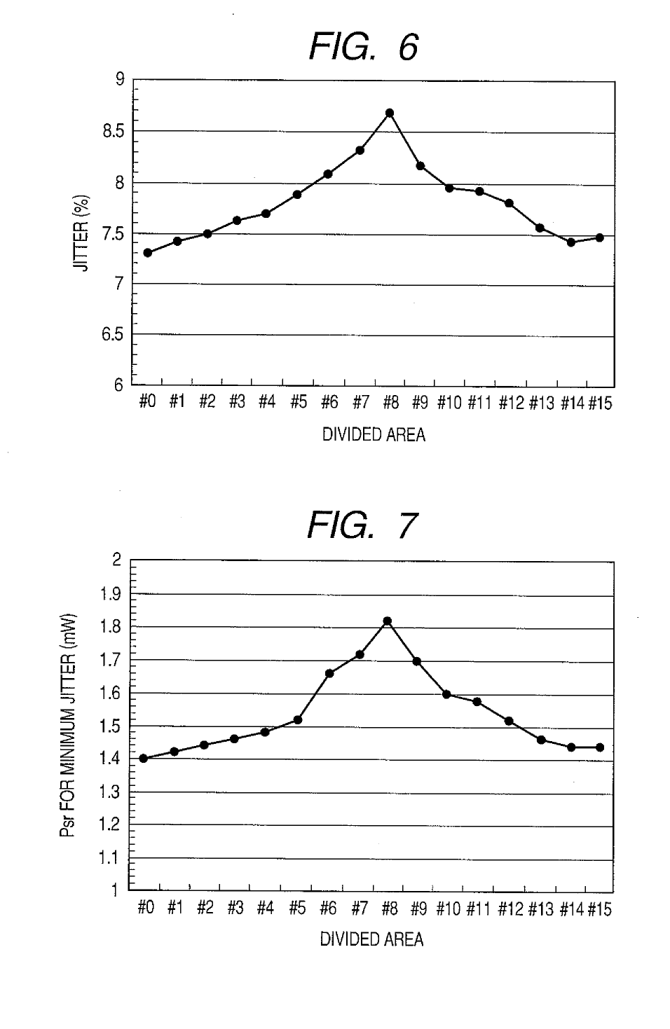

The emboss data part was reproduced with the recommended power Psr′ by focusing the light spot on the deeper layer (as viewed from the incident side). The drive divided the reproduced signal into 16 sections, which are numbered from 0 to 15 in terms of the rotational angle of the disk. The drive calculated jitter in each divided area. The results are shown in FIG. 6. It is noted that jitter in the divided areas #6 to 9 exceeded the maximum allowable value, which is 7.5%. A probable reason for this is that the light spot defocuses in these areas due to fluctuation of the total thickness of the cover layer and the spacer layer of the medium.

So, the drive measured Prs that gives the minimum jitter in each divided area, by varying Psr. The results are shown in FIG. 7. The Psr obtained here is the function of divided areas, which is represented as Psr(N), where N denotes the divided area number.

Then, the drive moved the head to the recording/reproducing test area provided at the radius 25.3-25.5 mm. When marks are recorded, Pu is written as the function Pu(N) of the divided area number N, and Pb was kept constant at 0.3 mW. Since the duty (tpu/tpb) of the pulse length of Pu and Pb was 0.6/0.4, α=0.6 holds in the formula (1).

$$\frac{( 0.6 \times {P}_{u} ( N ) + 0.4 \times 0.3 )}{{P}_{sr} ( N )} = \frac{( 0.6 \times 5.2 + 0.3 \times 0.3 )}{1.4} \\ ∴ {P}_{u} ( N ) = 3.86 {P}_{sr} ( N ) - 0.2 \qquad ( 3 )$$

Pu(N) was calculated from the foregoing formula. In other words, the recording power was varied in terms of the rotational angle of the disk. The drive performed test recording with this Pu(N), detected the mark edge position of each mark length, and adjusted the length and timing of the first pulse and last pulse such that the edge position is close to the desired position.

In this embodiment, the drive performed OWC in one track for one recording layer of the disk. The reason for this is that the spacer layer and cover layer of the disk were prepared by spin coating with a resin, but in the case where spin coating is used, the profile of the layer thickness unevenness within one turn of the disk approximately depends on the rotating angle of the disk and the dependency on the radial direction is low. However, the layer thickness unevenness hardly has the radius dependency but the absolute value of the film thickness sometimes gets thicker in the outer-radial area. The reason for low dependency on the radial direction is that in the case of spin coating the resin flows from the inner-radial area to the outer-radial area almost along the normal direction rotation. In this embodiment, the adjustment of the super-resolution reproducing condition was performed in the divided area #0. Reproduction of test data for one track turn in the divided area #0 was performed, Psr that minimizes jitter was found from reproduced signals, new Psr was calculated in proportion to the data of FIG. 7, and the recording power was calculated by using the formula (3). OWC was performed in the same way for the other layer of the dual layer medium, and it was possible to make jitter below 7.5% for the entire disk.

What is claimed is:

1. A method for recording and reproducing optical information comprising:
directing a first laser beam to an optical information recording medium, thereby forming record marks each smaller than the diameter of the spot formed by the first laser beam; and
directing a second laser beam of the same spot diameter as the first laser beam to the record marks, thereby performing super-resolution reproduction,
wherein the laser beam to be directed to the optical information recording medium for recording has its power adjusted in such a way that the power adjustment of the laser beam to form record marks and the power adjustment of the laser beam to perform super-resolution reproduction are carried out in pairs.

2. The method for recording and reproducing optical information according to claim 1, wherein the power of the laser beam to form record marks and the power of the laser beam to perform super-resolution reproduction are adjusted in proportion to each other.

3. The method for recording and reproducing optical information according to claim 1, wherein the power of the laser beam to perform super-resolution reproduction is varied in proportion to the average power of the laser beam to form record marks.

4. The method for recording and reproducing optical information according to claim 1,
wherein the laser beam for super-resolution reproduction is one having the DC waveform, the power of the laser beam for super-resolution reproduction is represented by the DC power value as a power index at the time of its proportional adjustment, and
wherein the laser beam to form record marks is composed of a plurality of pulses, and the power of the laser beam to form record marks is represented by the average power of that part excluding first pulse and last pulse from the plurality of pulses as a power index at the time of its proportional adjustment.

5. The method for recording and reproducing optical information according to claim 1,
wherein the power adjustment of the laser beam to form record marks is accomplished by test write, and
wherein the power adjustment of the laser beam for super-resolution reproduction is accomplished by test readout.

6. The method for recording and reproducing optical information according to claim 1, further comprising:
adjusting the power of the laser beam to form record marks of long marks by executing a first test write;
determining the power of the laser beam for super-resolution reproduction by executing a first test readout;
determining the power of the laser beam to form record marks for marks of all mark lengths including short marks by executing a second test write; and
determining the power of the laser beam for super-resolution reproduction of marks of all mark lengths including short marks by executing a second test readout.

7. The method for recording and reproducing optical information according to claim 6, wherein the first test write employs, as a test pattern, emboss pits formed at a prescribed position of the optical information recording and reproducing medium.

8. An optical information recording and reproducing apparatus which is so designed as to reproduce information from an optical information recording medium by directing a light beam to the optical information recording medium and has the function of forming record marks smaller than the wavelength of the light beam on the optical information recording medium and the function of performing super-resolution reproduction on the record marks, the apparatus comprising:
a control system to adjust in pairs the power of the light beam to form the record marks and the power of the light beam for super-resolution reproduction.

9. The optical information recording and reproducing apparatus according to claim 8, wherein the control system performs adjustment while keeping the power of the laser beam to form the record marks and the power of the laser beam for the super-resolution reproduction in proportion to each other.

10. The optical information recording and reproducing apparatus according to claim 8, wherein the control system adjusts the power of the laser beam to form the record marks by performing test write and adjusts the power of the laser bean for the super-resolution reproduction by performing test readout.

11. The optical information recording and reproducing apparatus according to claim 10, wherein the control system calculates a monitor index from reproduced signals of a test pattern for test write and calculates the optimum value of the recording power by using a monitor indicator function which includes at least the recording power as a variable and also includes the monitor index as a dependent variable.
